(19) United States
(12) Patent Application Publication
(10) Pub. No.: US 2004/0134295 A1
(43) Pub. Date: Jul. 15, 2004

(54) Engine compartment breather boot

(75) Inventors: Michel J. Vermoesen, Miamisburg, OH (US); Ryan M. Elking, Miamisburg, OH (US); Patrick T. MacLellan, Springboro, OH (US); Derek T. Dreischarf, Kettering, OH (US); Roger S. Sexton, Dayton, OH (US)

Correspondence Address: SCOTT A. MCBAIN, DELPHI TECHNOLOGIES, INC., Legal Staff, Mail Code: 480-410-202, P.O. BOX 5052, Troy, MI, 48007, US

(73) Assignee: DELPHI TECHNOLOGIES INC.

(21) Appl. No.: 10/341,100

(22) Filed: Jan. 13, 2003

(51) Int. Cl. F16J 15/50

(52) U.S. Cl. 74/18.2

(57) ABSTRACT

An improved method and apparatus for mounting a brake booster on a panel with an adapter are provided, through the use of a boot having a generally cup-shaped wall defining a flange for sealing a juncture between the brake booster and the adapter, a sealing lip for sealing a juncture between the boot and the adapter, and a hole for passage of the push rod, with the hole having a periphery for sealing the juncture between the boot and the push rod. The boot includes an air intake extending through the wall of the boot between the flange and the sealing lip.

### TECHNICAL FIELD OF THE INVENTION

This invention relates to brake systems for vehicles, and more particularly to brake boosters for such systems.

### BACKGROUND OF THE INVENTION

A typical brake system for a vehicle includes a device known as a brake booster, which is used to amplify the force applied directly to a brake pedal by an operator of the vehicle. The booster is typically mounted outside of the passenger compartment in the engine compartment on a firewall, dashboard, or panel forming the front wall of the passenger compartment. A push rod extends from the booster through an opening in the front panel for connection with a brake pedal assembly located within the passenger compartment. A flexible boot, or a sliding seal is provided around the push rod for environmentally sealing the hole in the front panel while allowing movement of the push rod by the brake pedal.

In most prior brake systems, atmospheric air for the booster is taken from the passenger compartment. During an application of the brake, air rushes into the booster through the boot that closes the hole in the front panel around the push rod. As air rushes through the holes in the boot, a “whooshing” noise is generated that can be disturbing to occupants of the passenger compartment. To alleviate this condition, brake manufacturers have developed concepts having air intake to the booster occurring in the engine compartment.

The shape of the booster, together with the need for supplying air to the booster breather port, generally require that some sort of mounting apparatus, including an adapter, be provided between the rear surface of the brake booster and the front panel of the passenger compartment. All interfaces between the adapter, the front panel of the passenger compartment, and the rear surface of the booster must be sealed against leakage of air, and entry into the passenger compartment of noise, dirt, water, or other solid and liquid contaminants that are present in the engine compartment.

In one prior approach, an adapter having a ventilation port allowing air from the engine compartment to enter an enclosed space inside the adapter is installed between the booster and a firewall separating the engine compartment and the passenger compartment. A flexible boot, having a tight fitting hole for passage of the push rod, is attached between the adapter and the firewall to seal the juncture of the adapter and the firewall, and to close the hole through the firewall. U.S. Pat. No. 4,932,275, to Bischoff et al, discloses this approach. U.S. Pat. No. 5,011,234, to Bischoff et al, discloses a similar approach, but adds a protecting sleeve that engages an adapter and projects from the adapter into a pleated bellows. These approaches are undesirable because they require complex sealing surfaces on a number of separate parts.

In another prior approach disclosed in commonly assigned U.S. patent application Ser. No. 10/015,113 to Vermoesen et al, filed Dec. 12, 2001, a spacer for mounting a brake booster on a wall includes both an adapter having a breather port and a boot formed integrally with the adapter. While this approach works well in some applications, and solves many of the problems present in other prior approaches, such a one-piece structure is not always desirable.

What is needed, therefore, is an improved apparatus and method for mounting a brake booster using an adapter in a manner that provides a solution to one or more of the problems described above.

### SUMMARY OF THE INVENTION

The present invention provides a method and apparatus for mounting a brake booster on a panel with an adapter through the use of a boot having a generally cup-shaped wall defining a flange for sealing a juncture between the brake booster and the adapter, a sealing lip for sealing a juncture between the boot and the adapter, and a hole for passage of the push rod, with the hole having a periphery for sealing the juncture between the boot and the push rod. The boot may also include an air intake extending through the wall of the boot between the flange and the sealing lip.

In one form of the present invention, an apparatus is provided for mounting a brake booster on a panel, where the booster includes a push rod and a power piston extending from a rear surface of the booster through a hole in the panel. The apparatus includes a boot and an adapter. The boot has a generally cup-shaped wall defining a flange for sealing a juncture between the brake booster and the adapter, a sealing lip for sealing a juncture between the boot and the adapter, and a hole for passage of the push rod, the hole having a periphery for sealing the juncture between the boot and the push rod. The adapter has a first end adapted for clamping the flange of the boot between the booster and the adapter, a second end adapted to abut the panel, and a tubular wall joining the first and second ends of the adapter and defining an inner surface of the adapter for engaging the sealing lip of the boot. The boot may include an air intake extending through the wall of the boot between the flange and the sealing lip, and the adapter may include a breather port for passage of air to and from the air intake of the boot. The breather port of the adapter may include a deflector in the breather port.

The present invention provides a single part extending from the booster, in the form of the boot, as the primary sealing member separating the engine compartment from the passenger compartment. The adapter can be made of a material, such as aluminum or steel or a plastic frame with a metal insert, having considerable strength for supporting the booster in a cantilevered position spaced away from the panel. The adapter is not directly involved in providing primary sealing of the air flowing in and out of the booster, and is only required to provide a secondary environmental seal between the adapter and the panel.

The present invention may also take the form of a method for mounting a push rod actuated brake booster on a panel with an adapter, and a boot having generally cupshaped wall defining a flange for sealing a juncture between the brake booster and the adapter, a sealing lip for sealing a juncture between the boot and the adapter, and a hole for passage of the push rod, the hole having a periphery for sealing the juncture between the boot and the push rod. The boot used in practicing a method according to the present invention may further include an air intake extending through the wall of the boot between the flange and the sealing lip for providing passage of air to and from the booster.

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is partial cross-section of an apparatus for mounting a brake booster on a panel, in accordance with the present invention; and

FIG. 2 is a perspective view of the apparatus of FIG. 1.

### DETAILED DESCRIPTION

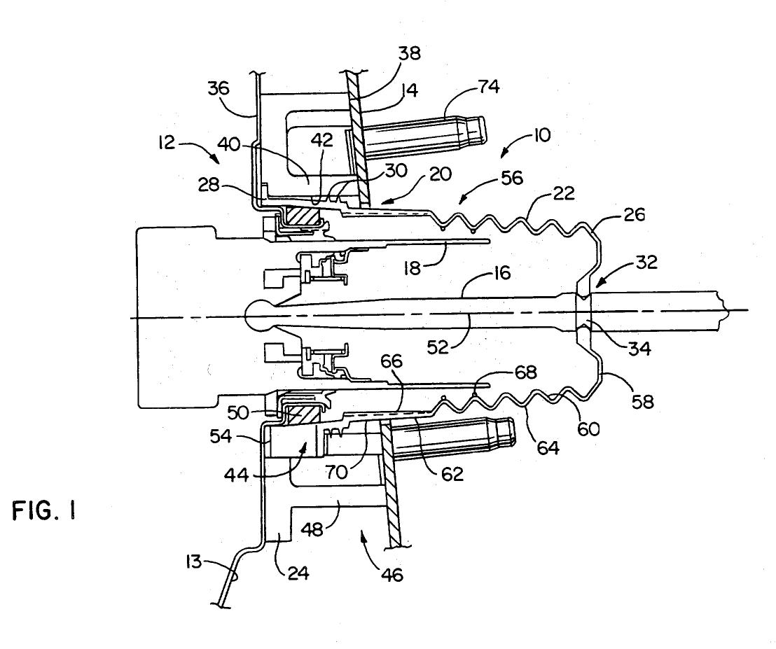

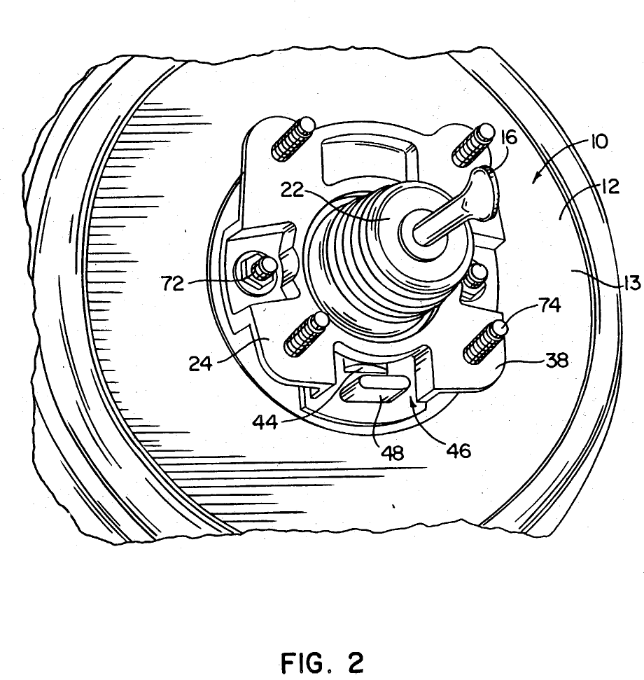

FIGS. 1 and 2 depict an apparatus 10 for mounting a brake booster 12 on a panel 14. The booster 12 includes a push rod 16 and a power piston 18 extending from a rear surface 13 of the booster 12. The push rod 16 and a power piston 18 extend through a hole 20 in the panel 14, when the booster 12 is mounted on the panel 14. The apparatus 10 includes a boot 22 and an adapter 24.

The boot 22 has a generally cup-shaped wall 26 defining a flange 28 for sealing a juncture between the brake booster 12 and the adapter 24, a pair of sealing lips 30 for sealing a juncture between the boot 22 and the adapter 24, and a hole 32 for passage of the push rod 16. The hole 32 has a periphery judiciously sized to stretch over the push rod 16, so that the push rod 16 can be inserted through the hole 32, and then to expand inward into a groove 34 for sealing the juncture between the boot 22 and the push rod 16.

The adapter 24 has a first end 36 adapted for clamping the flange 28 of the boot 22 between the booster 12 and the adapter 24, a second end 38 adapted to abut the panel 14. A tubular wall 40 joins the first and second ends 36, 38 of the adapter 24 and defines an inner surface 42 of the adapter 24 for engaging the sealing lips 30 of the boot 22.

The boot 22 is preferably made of a flexible material, such as rubber, or a thermoplastic polymer. The adapter 24 is preferably made from a metal material such as steel or aluminum, but in some applications may also be made from composite or polymer materials.

The boot 12 includes an air intake 44 extending through the wall 26 of the boot 22 between the flange 28 and the sealing lips 30. The adapter 24 includes a breather port 46 for passage of air, to and from the air intake 44 of the boot 22. The adapter 24 has a deflector 48 in the breather port 46, for blocking water splashed up in the engine compartment from entering the air intake 44 of the boot 22. It is preferred that the air intake 44 in the boot 22 and the breather port 46 in the adapter be at the bottom of the apparatus 10 so that any water that does get past the deflector 48 and into the boot 22 can drain out of the boot 22 by gravitational force. In some embodiments of the present invention, it may also be desirable to add a filter element 50 between the air intake 44 of the boot 22 and the rear wall of the booster 12, for keeping dust and moisture in the boot 22 from entering the booster 12.

The wall 26 of the boot 22 defines a longitudinal axis 52 of the boot 22. The flange 28 of the boot 22 extends generally radially outward from a booster end 54 of the boot 22 that is generally open radially inward of the flange 28. The boot 22 includes an annular segment 56 of the wall 26 disposed about and extending along the longitudinal axis 52 from the flange 28 to a closed axial facing end 58 of the boot 22, that includes the hole 32 for passage of the push-rod 16.

The annular segment 56 of the wall 26 of the boot 22 defines an inner surface 60 of the annular segment 56 of the wall 26 of the boot 22. The annular segment 56 of the wall 26 of the boot 22 includes a cylindrical section 62 thereof extending from the flange 28 along the longitudinal axis 52, and a convoluted bellows section 64 thereof extending along the longitudinal axis 52 from the cylindrical section 62 to the closed end 58 of the boot 22.

In order to preclude the boot 22 sealing against the power piston 18 and inhibiting operation of the booster 12, the boot 22 further includes one or more protrusions 66, 68 extending inward from the inner surface 60 of the annular segment 56 of the wall 26 of the boot 22, for spacing the inner surface 60 of the annular segment 56 of the wall 26 away from the power piston 18 of the booster 22. The protrusions in the cylindrical section 62 are provided in the form of a plurality of longitudinally extending webs 66. The protrusions in the convoluted section 64 are provided in the form of a plurality small nubs 68 spaced circumferentially from one another and extending inward from an inner diameter of the convolutions.

The cylindrical section 62 of the annular segment 56 of the wall 26 of the boot 22 defines an outer surface 70 of the boot 22. The sealing lips 30 extend circumferentially outward from the outer surface 70 of the boot 22 of the cylindrical section 62 of the wall 26.

As shown in FIG. 2, the adapter 24 is attached to the booster 12 by a pair of studs 72 extending from the booster. The adapter 24 includes four mounting studs 74 for attaching the adapter to the panel 14.

While the embodiments of the present invention disclosed herein are presently considered to be preferred, various changes and modifications can be made without departing from the spirit and scope of the invention. The term “panel,” as used herein, is intended to include structures known in the automotive or vehicle manufacturing industry as “mod plates,” “firewalls,” “dashboards,” and “mud guards.”

The scope of the invention is indicated in the appended claims. We intend that all changes or modifications within the meaning and range of equivalents are embraced by the claims.

We claim:

1. A boot for a push rod actuated brake booster mounted on a panel with an adapter, the boot comprising a generally cup-shaped wall defining:
a flange for sealing a juncture between the brake booster and the adapter;
a sealing lip for sealing a juncture between the boot and the adapter; and
a hole for passage of the push rod, the hole having a periphery for sealing the juncture between the boot and the push rod.

2. The boot of claim 1 further comprising an air intake extending through the wall of the boot between the flange and the sealing lip.

3. The boot of claim 1 wherein:
the wall of the boot defines a longitudinal axis of the boot;
the flange extends generally radially outward from a booster end of the boot that is generally open radially inward of the flange; and
the boot includes an annular segment of the wall disposed about and extending along the longitudinal axis from the flange to a closed axial facing end of the boot defining the hole.

4. The boot of claim 3 further comprising an air intake extending through the annular segment of the wall of the boot between the flange and the sealing lip.

5. The boot of claim 3 wherein a portion of the wall of the boot is flexible.

6. The boot of claim 5 wherein a portion of the annular segment of the wall is flexible.

7. The boot of claim 5 wherein the annular segment of the wall defines an inner surface and the boot further includes one or more protrusions extending inward from an inner surface of the annular segment of the wall, for spacing the inner surface of the annular segment of the wall away from the booster.

8. The boot of claim 6 wherein the annular segment of the wall includes a cylindrical section thereof extending from the flange along the longitudinal axis, and a convoluted bellows section thereof extending along the longitudinal axis from the cylindrical section to the closed end of the boot.

9. The boot of claim 8 wherein the cylindrical section of the annular segment of the wall defines an outer surface of the boot and the sealing lip extends circumferentially outward form the outer surface of the boot from the cylindrical section of the wall.

10. The boot of claim 8 wherein the convoluted bellows section of the annular segment of the wall defines an inner surface and the boot further includes one or more protrusions extending inward from an inner surface of the annular segment of the wall, for spacing the inner surface of the annular segment of the wall away from the booster.

11. An apparatus for mounting a brake booster on a panel, the booster having a push rod and a power piston extending from a rear surface of the booster through a hole in the panel, the apparatus comprising:
a boot having a generally cup-shaped wall defining a flange for sealing a juncture between the brake booster and the adapter, a sealing lip for sealing a juncture between the boot and the adapter, and a hole for passage of the push rod, the hole having a periphery for sealing the juncture between the boot and the push rod; and
an adapter having a first end adapted for clamping the flange of the boot between the booster and the adapter, a second end adapted to abut the panel, and a tubular wall joining the first and second ends of the adapter and defining an inner surface of the adapter for engaging the sealing lip of the boot.

12. The apparatus of claim 11 wherein the boot further comprises an air intake extending through the wall of the boot between the flange and the sealing lip.

13. The apparatus of claim 12 wherein the adapter further includes a breather port for passage of air to and from the air intake of the boot.

14. The apparatus of claim 13 wherein the adapter further includes a deflector in the breather port.

15. The apparatus of claim 13 further including a filter element disposed between the air intake and the booster.

16. The apparatus of claim 13 wherein:
the wall of the boot defines a longitudinal axis of the boot;
the flange of the boot extends generally radially outward from a booster end of the boot that is generally open radially inward of the flange; and
the boot includes an annular segment of the wall disposed about and extending along the longitudinal axis from the flange to a closed axial facing end of the boot defining the hole.

17. The apparatus of 16 wherein a portion of the annular segment of the wall of the boot is flexible.

18. The apparatus of claim 17 wherein the annular segment of the wall of the boot defines an inner surface of the annular segment of the wall of the boot, and the boot further includes one or more protrusions extending inward from an inner surface of the annular segment of the wall, for spacing the inner surface of the annular segment of the wall away from the booster.

19. The apparatus of claim 18 wherein the annular segment of the wall of the boot includes a cylindrical section thereof extending from the flange along the longitudinal axis, and a convoluted bellows section thereof extending along the longitudinal axis from the cylindrical section to the closed end of the boot.

20. The apparatus of claim 19 wherein the cylindrical section of the annular segment of the wall of the boot defines an outer surface of the boot and the sealing lip extends circumferentially outward from the outer surface of the boot from the cylindrical section of the wall.

21. The apparatus of claim 19 wherein the convoluted bellows section of the annular segment of the wall of the boot defines an inner surface of the annular segment of the wall, and the boot further includes one or more protrusions extending inward from an inner surface of the annular segment of the wall, for spacing the inner surface of the annular segment of the wall away from the booster.

22. A method for mounting a push rod actuated brake booster on a panel with an adapter, the method comprising:
installing a boot having a generally cup-shaped wall defining:
a flange for sealing a juncture between the brake booster and the adapter;
a sealing lip for sealing a juncture between the boot and the adapter; and
a hole for passage of the push rod, the hole having a periphery for sealing the juncture between the boot and the push rod.

23. The method of claim 22 wherein the boot further includes an air intake extending through the wall of the boot between the flange and the sealing lip for providing passage of air to and from the booster.
